(19) United States
(12) Patent Application Publication
(10) Pub. No.: US 2004/0250352 A1
(43) Pub. Date: Dec. 16, 2004

(54) Multi-functional pen structure

(76) Inventor: Shih-Hua Yeh, Taipei City (TW)

Correspondence Address: Shih-Hua YEH, P.O. Box No. 6-57, Junghe, Taipei 235, TW

(21) Appl. No.: 10/457,412

(22) Filed: Jun. 10, 2003

(51) Int. Cl. B26B 11/00

(52) U.S. Cl. 7/160

(57) ABSTRACT

A multi-functional pen structure includes an upper cover and a pen shaft. When the rotatable upper cover is turned, a refill therein is pushed out of or withdrawn into the pen. The characteristics of the invention are that, the upper cover is disposed with an accommodation chamber for pivotally disposing a pair of scissors, a blade, and a nail clipper having a screwdriver at an outer end thereof. The aforesaid tools are stored within the accommodation chamber when not in use and extracted out of the accommodation chamber when in need.

### BACKGROUND OF THE INVENTION

(a) Field of the Invention

The invention relates to a multi-functional pen structure, and more particularly, to a pen structure integrated with various tools, thereby bringing practicability for being readily portable while also having functions of other tools such as scissors, knives, nail clippers and screwdrivers.

(b) Description of the Prior Art

Living in a modern metropolis, a most frequent problem that one may likely be confronted with is unexpected needs of a pen for writing or jotting down notes. Therefore, it is quite essential that an up-to-date person carries along a pen. However, merely carrying a pen does not always effectively solve most things that one may probably encounter. For instance, a cutting tool is needed for cutting paper or other objects; and according to various types of objects to be cut, or requirements of depths to be cut, cutting tools are provided with cutting edges of either being sharp or blunt. Or, for dismantling and examinations of mechanical parts due to accidental falling off of screws, an immediate need of a screwdriver is arisen for assembly or disassembly. Or even, clipping of nails and cuticles, and cutting of threads are some of the most common problems that one may come across. These aforesaid matters are quite unlikely to be solved using a pen that one carries with.

Furthermore, to meet demands of tools namely knives, scissors, screwdrivers, can openers and nail clippers, weighty Swiss knives including all functions of the aforesaid tools are available on the market. Yet, a Swiss knife is so heavy that it is inappropriate to be placed in a chest pocket and is often stored in a certain spot within a bag. When going out and carrying a pen and a Swiss knife in separate places, searching for the knife in need from the bag is often conducted in a hurry-scurry manner. In addition, one does not usually need many tools at all time, and thus carrying a Swiss knife is in fact somewhat redundant and inconvenient.

### SUMMARY OF THE INVENTION

Therefore, in the view of frequent needs of pens and certain tools that are preferably easily carried along and unlikely to be lost, a best solution is to keep these certain tools most often used within a pen.

The primary object of the invention is to provided a rotatable pen having an enlarge portion at a top end thereof, so as to store tools such as a small blade, a small pair of scissors, a nail clipper and a screwdriver in an interior of the enlarge portion. The tools are in a form of a pen shaft of the rotatable pen when stored, and can be directly extracted for further usage, thereby providing a design having ready portability and practicability.

### BRIEF DESCRIPTION OF THE DRAWINGS

FIG. 1 shows an exploded structural view according to the invention.

FIG. 2 shows a schematic view of an appearance according to the invention.

FIG. 3 shows a structural side view according to the invention.

FIG. 4 shows a schematic view illustrating the invention being utilized.

### DETAILED DESCRIPTION OF THE PREFERRED EMBODIMENTS

To better understand the contents of the invention, detailed descriptions shall be given with the accompanying drawings hereunder.

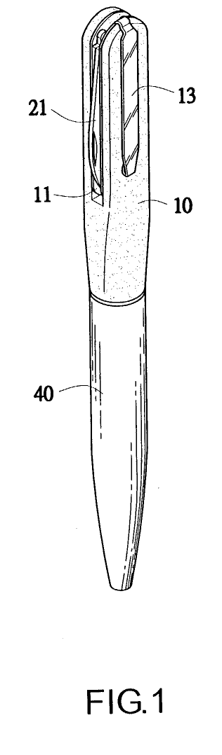

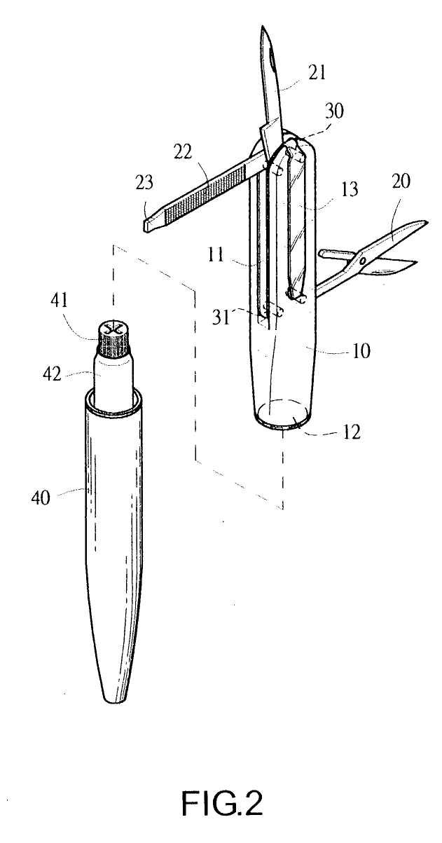

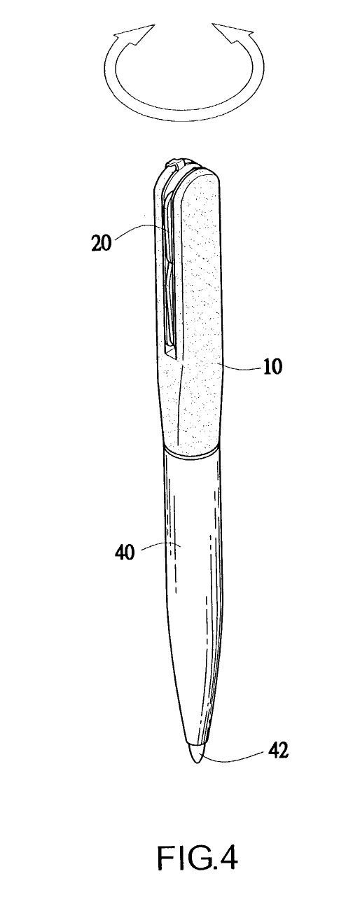

Referring to FIGS. 1 and 2, the invention comprises an upper cover 10 and a pen shaft 40. The upper cover 10 is disposed with an accommodating opening 12 at a lower end thereof and a pen clip 13 at an external top end thereof. The pen shaft 40 is disposed with a refill 42 at an interior thereof, and the refill 42 is provided with a rotation pole 41 at a top end thereof. The upper cover 10 is accommodated around an upper portion of the pen shaft 40, and the accommodating opening 12 is joined with the rotation pole 41, such that the rotation pole 41 is simultaneously turned when rotating the upper cover 10. Referring to FIG. 4, the refill 42 is then pushed outward for writing, and can also be withdrawn into the pen when not in use.

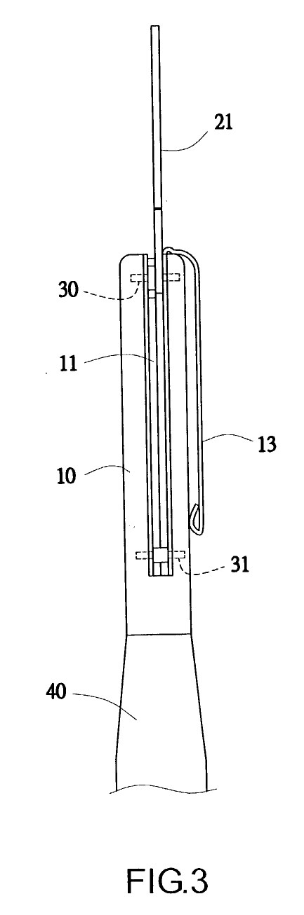

Referring to FIGS. 1, 2 and 3, the characteristics of the invention are that, the upper cover 10 is an enlarged and flat-shaped portion vertically provided with an accommodation chamber 11; a pivotal axis 31 is penetrated through a foot portion of a pair of scissors 20 at one side of the accommodation chamber 11, so as to pivotally fasten the scissors 20 at one side of the accommodation chamber 11; another pivotal axis 30 is penetrated through end portions of a blade 21 and a nail clipper 22, so as to pivotally fasten and store the blade 21 and the nail clipper 22 at the other side of the accommodation chamber 11; an outer end of the nail clipper 22 is further provided with a flat screwdriver 23; and the aforesaid scissors 20, the blade 21, the nail clipper 22 and the screwdriver 23 are stacked on top of one another within the accommodation chamber 11 when not in use, and any of the aforesaid tools may be extracted out of the accommodation chamber 11 when needed as shown in FIG. 1.

The design according to the invention has the following excellences when being applied:

1. Apart from writing functions of a pen, the invention artfully disposes most commonly used tools such as a pair of scissors, a blade, a nail clipper and a screwdriver within the pen, thereby enabling the invention to be readily carried with practicability in daily life.

2. The upper cover according to the invention is an enlarged and flat-shaped portion, and thus application of forces are facilitated when rotating the pen shaft below.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A multi-functional pen structure comprising an upper cover and a pen shaft; wherein:
the upper cover is provided with an accommodating opening at a lower end thereof and a pen clip at an external upper end thereof; the pen is disposed with a refill at an interior thereof, and the refill is provided with a rotation pole at an upper end thereof; the upper cover is accommodated around an upper end of the pen shaft, and the accommodating opening is joined with the rotation pole, such that the refilled is pushed out of the pen for writing or withdrawn into the pen when simultaneously turning the rotation pole by rotating the upper cover; and the characteristics of the invention are that:
the upper cover is provided with an accommodation chamber; a pivotal axis is penetrated through a foot portion of a pair of scissors at one side of the accommodation chamber, thereby pivotally fastening the scissors at one side of the accommodation chamber; another pivotal axis is penetrated through end portions of a blade and a nail clipper, thereby pivotally fastening and storing the blade and the nail clipper at the other side of the accommodation chamber; an outer end of the nail clipper is further provided with a flat screwdriver; and the aforesaid scissors, the blade, the nail clipper and the screwdriver are stacked on top of one another within the accommodation chamber when not in use, and any of the aforesaid tools may be extracted out of the accommodation chamber when needed.

2. The multi-functional pen structure in accordance with claim 1, wherein the upper cover is an enlarged and flat-shaped portion.
